(19) United States
(12) Patent Application Publication
(10) Pub. No.: US 2017/0091712 A1
(43) Pub. Date: Mar. 30, 2017

(54) Apparatus and Method for Employee Time Entry and Accounting

(71) Applicant: Gregg Alper, Coral Springs, FL (US)

(72) Inventor: Gregg Alper, Coral Springs, FL (US)

(21) Appl. No.: 15/279,554

(22) Filed: Sep. 29, 2016

Related U.S. Application Data
(60) Provisional application No. 62/234,367, filed on Sep. 29, 2015.

(51) Int. Cl. G06Q 10/10; H04L 29/08; H04W 4/02

(52) U.S. Cl. CPC G06Q 10/1091; H04W 4/021; H04L 67/306; H04L 67/24; H04L 67/12; H04L 67/18; H04L 67/14; G06Q 10/1093; H04W 84/12

(57) ABSTRACT

A method and system for tracking an individual having a pre-defined schedule within a location. The method and system comprise inputting unique identification data for a mobile device connected to the individual into a database, inputting a schedule for the individual into a server, followed by tracking, via at least one signal, the individual's location in at least one location, wherein the location is determined by scanning for the unique identification data of the mobile device and tracking the mobile device once the individual's mobile device is within a pre-defined signal area as determined by the range of the signal and once the mobile device is connected to the signal, retrieving, via the server, the schedule of the individual, which, in response to logging the mobile device, automatically clocks in the individual if the employee is currently scheduled to be in the one location according to the previously inputted schedule, recording time spent within the at least one location in real time, blocking the individual's use of certain websites and mobile applications as determined by an administrator while in the one location, automatically clocking out the individual from the at least one location if the individual disables the connection to the signal; and reporting the real time recorded time to the server to store in a central profile. The method and system includes the ability for polling of the mobile device to determine whether the mobile device is still within the signal area and to allow for use of a secondary device if the mobile device powers down due to low battery while still at the location during the schedule.

### RELATED APPLICATION DATA

This application claims priority to Provisional Application No. 62/234,367 filed on Sep. 29, 2015 and entitled “Apparatus and Method for Employee Time Entry and Accounting.” The content of this application is fully incorporated herein for all purposes.

### TECHNICAL FIELD

This disclosure relates to a system and method for tracking employees. More particularly, the present invention relates a system and method for tracking employee's time through the use of a combination of signals and the individual digital signature of an employee's handheld device.

### BACKGROUND OF THE INVENTION

As mobile device technology advances and becomes more a part of everyday life, the attentiveness and efficiency of employees in the workplace has lowered. Combine this rapidly advancing technology with the time consuming task of reconciling employee time sheets and there is a high likelihood of a company's profits being affected.

There presently exists a need for employers to reliably keep track of their employees without relying too heavily on the employee themselves. Other methods and apparatuses have been designed but none have the reliability needed by businesses.

Previous systems used geo-fencing to track when and where employees entered a particular work zone. For example, U.S. Pat. No. 9,020,848 to Ridge et al. discloses a system whereby an employee has an application on their mobile device running at all times while the employee is at work. This application would maintain contact with a signal and check against an employee schedule to make sure the employee is actually supposed to be at work. However, an issue with this method is evident by the fact that the employee has to have the application running in order for the system to work. Additionally, Ridge's method focuses on the signal produced by the mobile device recognizing the signal from the workplace. The present invention improves on this by instead having the server get information about the individual employee's mobile device through a central access hub which can either push the employee's data to the server or have the server reach out to the central access hub to retrieve information about the employee. Either way, it is the employee's mobile device, and not the workplace server, which is the identifying feature used to determine whether the employee is physically present at the workplace.

Another reference that is improved upon by the present invention is U.S. Pat. No. 9,070,162 to Cherry et al. Cherry features a similar system to Ridge whereby the employee has an application running on their mobile device that the employee must have running in order for the system to work. In fact, Cherry requires the employee to perform a check in operation and to take a picture for verification. Cherry also has the mobile device in direct communication with the low energy signal server to determine a Wi-Fi location. The present invention improves upon this method by requiring no actions to be taken by the employee at all. Instead, the phone interacts directly with the central access hub which then acts an intermediate for the signal server, controlling the data being sent between the central access hub and the server.

Similarly, U.S. Pat. No. 8,126,788 to Pappas et al. and United States Application No. 2015/0119070 to Harris et al. describe applications that must be run through the mobile device. Pappas requires the user to select or activate the software through a menu or some other form of employee interaction and Harris describes a locator device physically attached to a mobile device so that a person can be tracked within previously mapped Wi-Fi area. The present invention improves upon these features by removing the elements of user interaction and having a central access hub perform the area mapping.

Therefore, it is an object of this invention to provide an improvement which overcomes the aforementioned inadequacies of the prior art devices and methods and provides an improvement which is a significant contribution to the advancement of the employee tracking art.

Another object of this invention is to provide employers with a reliable way of tracking time and location of employees without needing employees themselves to take any action.

Another object of this invention is to provide an automatic electronic method of quickly reconciling employee time sheets.

Another object of this invention is to provide a method of clocking in and clocking out employees who choose to slack off at work through the use of the Internet by automatically clocking the employee out when the employee turns off the workplace Wi-Fi signal blocking Internet use.

Another object of this invention is to provide an apparatus that can facilitate the method described herein.

Another object of this invention is to provide a method and apparatus that will save battery power on mobile devices by having all identification functions run through a central access hub.

Another object of this invention is to provide an apparatus that can relay information to a network server, identify individual employee's mobile device identification data, and either block, limit, or record employee Internet usage while on the clock.

The foregoing has outlined some of the pertinent objects of this invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a system and method for tracking an individual having a pre-defined schedule within a location comprising the steps of inputting unique identification data for a mobile device connected to the individual into a database, inputting a schedule for the individual into a server, followed by tracking, via at least one signal, the individual's location in at least one location, wherein the location is determined by scanning, via a central access hub, for the unique identification data of the mobile device and tracking and logging the mobile device once the individual's mobile device is within a pre-defined signal area as determined by the range of the signal and once the mobile device is connected to the signal, retrieving, via the server, the schedule of the individual, which, in response to logging the mobile device, automatically clocks in the individual if the employee is currently scheduled to be in the one location according to the previously inputted schedule, recording time spent within the at least one location in real time, blocking the individual's use of certain websites and mobile applications as determined by an administrator while in the one location, automatically clocking out the individual from the at least one location if the individual disables the connection to the signal; and reporting the real time recorded time to the server to store in a central profile.

In accordance with one embodiment, the user the method and system is intended for is an employee and the particular location is a work zone such as an office or construction site. A number of different work zones can utilize the present invention. Further, the signal can be a number of different signals including, but not limited to, GPS, Bluetooth, Near Field Communication, and WiFi.

For example, an employee may walk into a work zone containing a central access hub in communication with the employee's mobile device via Bluetooth or WiFi. The central access hub will trigger an alert and launch a corresponding mobile application on the employee's mobile device. This triggering is performed by sending, for example, a Bluetooth signal to the device. For example, mobile devices running Apple software use the “Location Services” in iOS which can alert applications when you approach or leave a location using what Apple terms an “iBeacon” which can be something as simple as a checkout counter in a retail store or a laptop running specific hardware. Once the alert is triggered on the mobile device, the employee can launch the application with a click or a swipe. The same functionality is available on Android devices. Once logged in, the employee will be considered clocked in. Once clocked in, an administrator can limit access to certain social media website, web browsing in general, or messaging. The mobile device will be periodically polled by the central access hub. The polling can take place every fifteen minutes, every hour, or at the beginning and end of a shift. The information gleaned from the poll will be uploaded to a cloud server using existing WiFi/Internet infrastructure at the work zone. Preferably, one of the pieces of information relayed to the server is battery life because if the employee's device battery dies while at work, the server will allow the employee to clock out using a secondary device, which is not available if the employee's mobile device still has power. The system will preferably automatically clock an employee out if the wireless device is not reachable for any poll unless the battery level of the employee's mobile device is less than 10% whereby the server will assume that the employee's mobile device has died and that the employee is still present in the work zone.

In accordance with another embodiment, the user the method and system is intended for is a student and the particular location is an academic setting.

In accordance with the present invention, the primary vehicle for the method and system is the central access hub. The central access hub is main communication port between the server containing the user's schedule and individual mobile device identification data. The central access hub is configured to connect with the user's mobile device through the signal when the mobile device is within signal range of the central access hub. Once connected via signal, a combination of signals can be used to increase time recording accuracy.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures and methods for carrying out the same purposes of the present invention. It should also be realized by those skilled in the art that such equivalent constructions and methods do not depart from the spirit and scope of the invention as set forth in the appended claims.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 illustrates a flowchart of an exemplary embodiment of the present invention resulting from an employee entering a location.

FIG. 2 illustrates an exemplary embodiment of the present invention showing the effects of going into and out of a signal area with regard to clocking in and clocking out an employee.

FIG. 3 illustrates an exemplary embodiment of the present invention showing the effects of a limited Internet connection when a user is both inside and outside the signal area.

FIG. 4 illustrates an exemplary embodiment of the present invention showing how FIGS. 2 and 3 interact with one another when the user is both inside and outside the signal area.

FIG. 5 illustrates a flowchart of an alternative embodiment of the present invention resulting from an employee entering a location.

FIG. 6 illustrates a flowchart of the polling process used by the present invention to determine whether use of a secondary device is necessary.

Similar reference numerals refer to similar parts throughout the several views of the drawings.

### DETAILED DESCRIPTION OF THE DRAWINGS

The following description is of a preferred embodiment presently contemplated for carrying out the invention. This description is not to be taken in a limiting sense, but is made merely for the purpose of describing one or more preferred embodiments of the invention. The scope of the invention should be determined with reference to the claims.

As shown in the accompanying drawings, for purposes of illustration, the present invention uses specific methods and technologies to clock an individual in or out based on coordinating an individual's location with mobile device identification data using a central access hub.

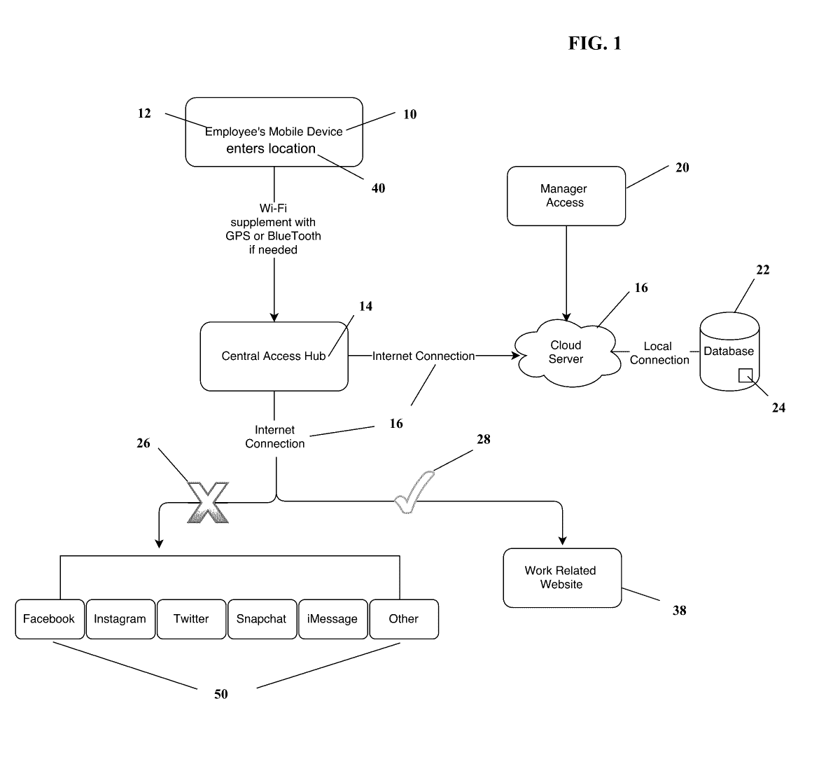

In FIG. 1, an individual 12 enters a particular location 40. An individual's mobile device 10 then communicates with a central access hub 34. The central access hub emits a signal 30 which creates a signal area 32. Once the individual's mobile device 10 is within this signal area 32, it can communicate with the central access hub 34 preferably using an application. The central access hub 34 recognizes the mobile device 10 through mobile device identification data 36. This mobile device identification data 36 can be a plurality of identification methods but the preferred method is through the use of a MAC address. MAC addresses are unique identifiers assigned to network interfaces for communications on the physical network segment and is normally stored in a device's hardware such as read-only memory or some other firmware. The mobile device 10 can connect to another device using MAC addressing using the transmission control protocol (TCP). The TCP is invoked, packets are exchanged between the two devices in the address resolution protocol (ARP). The mobile device 10 and central access hub 34 can be configured to store the ARP data in an ARP table or cache. The signal 30 also allows the central access hub 34 to communicate directly with a server 16 and establish an Internet connection 18.

Initial setup of the system would require mapping of the mobile device identification data 36 to the individual's name, social security number, employee identification number, a combination, or any other type of identifying information such as the individual's schedule 54. The mobile device identification data 36 is stored in a database 22, preferably on the server 16, in a central profile 24. Manager access 20 is allowed on this server so that a manager or administrator can access the identifying information and track the individual 12. Whenever the individual 12 is “clocked in” with the central access hub, their activity is tracked and stored in the central profile 24.

Preferably, the signal 30 will be a standard 802.11 Wi-Fi signal. However, other forms of signals can be used including, but not limited to, other forms of Wi-Fi, Bluetooth Low Energy (BLE), global positioning system (GPS), or Near Field Communication (NFC) signals. A location 14 may have more than one central access hub 34 communicating with a server 16, each generating a signal 32. It is the server 16 communicating with the central access hub 34 that allows the server 16 containing the identifying information to match the mobile device identification data 36 to the individual 12. Preferably, the server 16 retrieves data from the central access hub 34 as needed. Alternatively, the central access hub 34 could push the mobile device identification data 36 to the server 16 once the individual 12 is within the signal area 30.

Once the mobile device 10 is connected to the signal 30, the Internet connection 18 on the mobile device 10 can be controlled. An administrator 62 may block certain websites and applications 50 from the individual's use such as social media, news outlets, messaging applications, and other websites or applications that would affect the individual's attention. Administrator approved websites and applications 38 would still be allowed. This list of approved websites and applications 38 can be stored centrally on the server 16 so that the server 16 can converse with the application and make decisions regarding websites and applications 38. The server 16, via the central access hub 34, can make either a “block” decision 26 or a “grant” decision 28. The “grant” decision 28 is reserved for those administrator approved websites and applications 38. FIG. 1 shows a situation where the individual 12 is an employee and the location 40 is a work place and so work related websites are allowed. It will be appreciated, however, that this configuration could be used in other settings such as a classroom or camp or other location where attendance needs to be monitored and tracked.

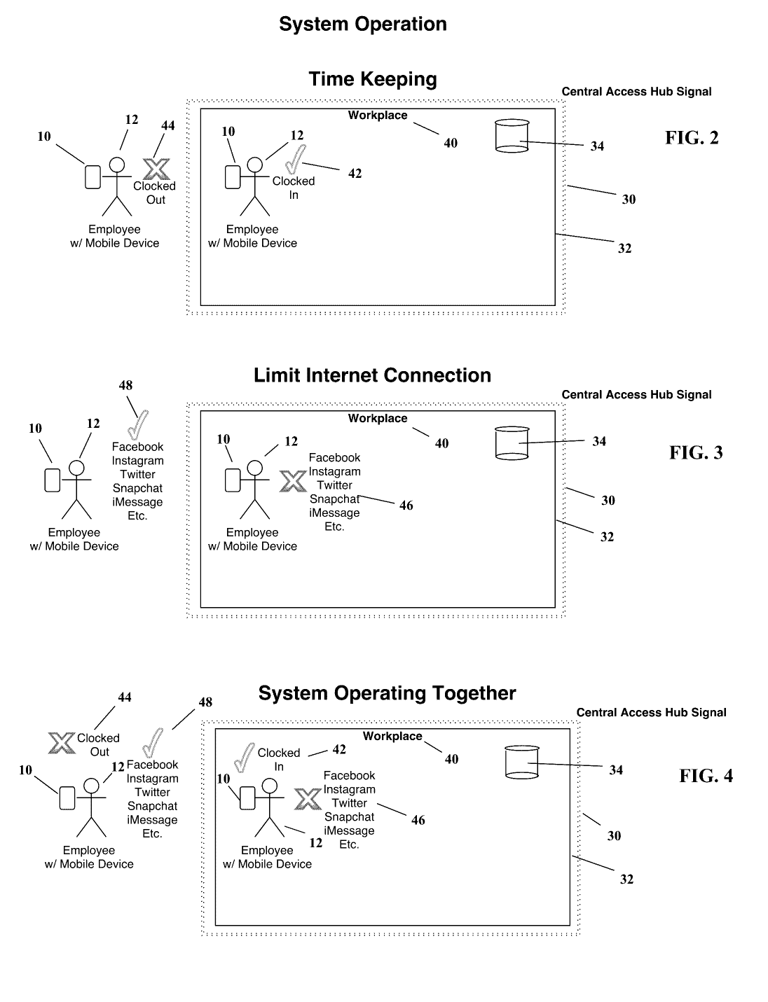

FIG. 2 shows the effect of the signal 30 with regard to automatically clocking in or clocking out the individual. Outside of the signal area 30 emanating from the central access hub 34 the individual 12 is considered clocked out. Once inside the signal area 30, the individual 12 will automatically be clocked in by virtue of the central access hub's 34 recognizing the mobile device identification data 36 and the individual 12 logging into an appropriate application. Once recognized, the central access hub 34 checks the mobile device identification data 36 located on the server 16 and makes a determination. Inside the signal area, the central access hub 34 makes a “clocked in” determination 42 while the central access hub 34 makes a “clocked out” determination 44 outside the signal area.

FIG. 3 shows the effect of the signal area 30 with regard to Internet connection and usage. Initially, the administrator 62 determines which websites are not allowed for an individual once within range of the signal area. Sample applications and websites include Facebook®, Instagram®, Twitter®, Snapchat®, iMessage®, and other related applications and websites. Outside of the signal area 30, created by the emanation of a signal 32 from the central access hub 34, the individual is able to access any application or website on their mobile device that they desire. However, once inside the signal area 30 and recognized by the central access hub 34, the individual's 12 mobile device 10 blocks any and all applications and websites based on the administrator's 62 determination. Much like the “clock in” determination, inside the signal area 30, the central access hub 34 makes a “blocked” determination 46 while the central access hub 34 makes a “not blocked” determination 48 outside the signal area.

FIG. 4 summarizes the operation of the system as a whole. The central access hub 34 generates a signal 32, creating a signal area 30. Outside of this signal area 30, an individual's 12 mobile device 10 is clocked out and able to access all media on the mobile device 10 due to the “clocked out” determination 44 and “not blocked” determination 48 made by the central access hub 34. Inside the signal area 30, the individual's 12 mobile device 10 is automatically clocked in and blocked from any non-approved applications and websites, as determined by an administrator 62, due to “clocked in” determination 42 and “blocked” determination 46 made by the central access hub 34.

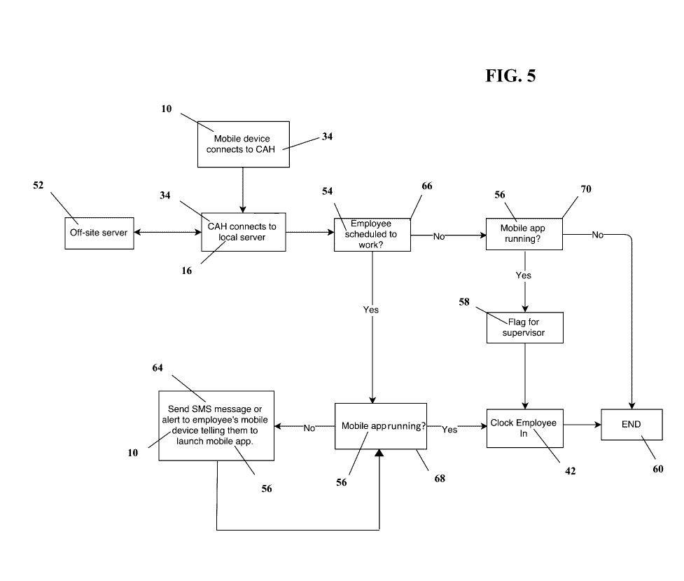

FIG. 5 provides a flow chart for an alternative embodiment of the invention. First, an individual 12 enters the location 40 and the individual's 12 mobile device 10 automatically connects with the central access hub (CAH) 34. The central access hub 34 has constant communication with an off-site server 52 and the local server 16. Periodically, the off-site server 52 communicates with the local server 16 to exchange information. Once the mobile device 10 is connected to the central access hub 34, data about the individual 12 is exchanged with the local server 16 and the individual's 12 schedule 54 is checked 66. If the individual's schedule 54 matches, the local server 16 will attempt to communicate with the mobile device 10 to see if an associated application 56 is running 68. The associated application 56 is not running on the individual's 12 mobile device 10, the local server 16 will send an alert 64 to the individual's 12 mobile device 10 telling the individual 12 to launch the associated application 56. The individual 12 will then launch the associated application 56. If the associated application 56 is running on the mobile device 10, then the local server 16 will automatically clock in the individual 12 based on the “clock in” determination 42 and the procedure is complete 60. If the individual 12 and the schedule 54 do not match, the local server 16 will attempt to communicate with the mobile device 10 and see if the associated application 56 is running 70. If the associated application 56 is running, a flag 58 will be raised, attached to the individual's schedule 54, and sent to an administrator 62. If the associated application 56 is not running and the individual 12 does not match the schedule 54 on file, the procedure is complete 60 and the individual 12 is not clocked in. As in the preferred embodiment, once clocked in, the individual 12 will only have access to administrator approved websites and applications 38 and those certain websites and applications 50 will be blocked.

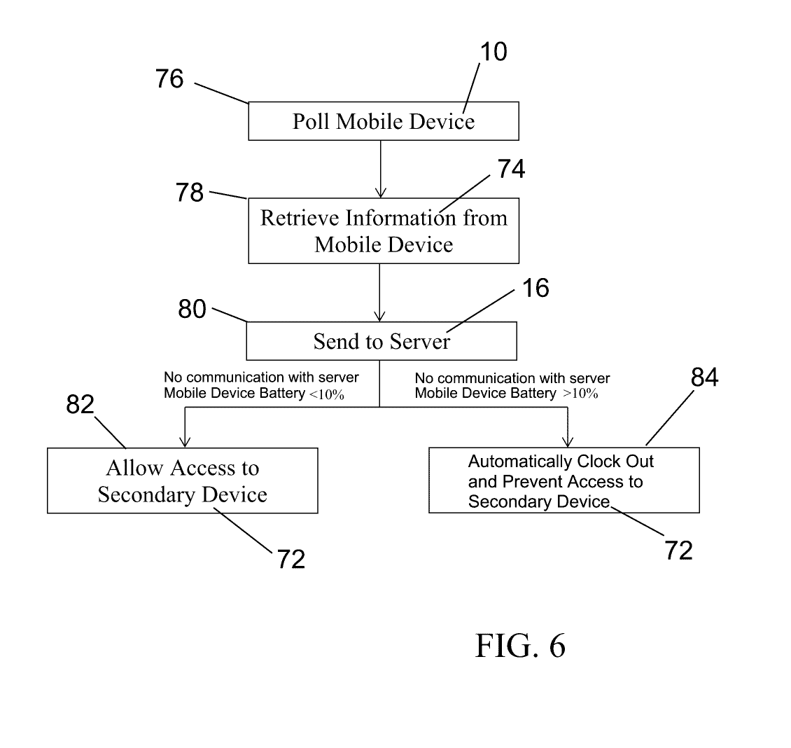

As shown in FIG. 6, once clocked in, the server 16 will periodically poll 76 the mobile device 10 and retrieve 78 certain information 74 such as battery life, location, and time spent at the location 40. This periodic poll 76 can take the form of a ping or other periodic communication and can be done at scheduled intervals. These intervals can be every 15 seconds, every minute, every 15 minutes, every 30 minutes, or whatever amount of time the administrator 62 or relevant manager determines to be appropriate. If the mobile device 10 runs out of battery, this information will be relayed 80 to the server 16 which will allow the individual 12 to clock out using a secondary device 72 such as a computer or laptop devoted to the location 40. The individual 12 will be automatically clocked out 84 from the location 40 if the server 16 cannot communicate with the mobile device 10 unless the previous poll indicated the individual's battery was at less than 10% at which point the server 16 will assume that the mobile device 10 shut off from lack of power and that the individual 12 is still at the location 40 allowing the individual 12 to access 84 the secondary device 72. The secondary device 72 cannot be used to clock out if the server 16 can still communicate with the mobile device 10.

The invention being described, it will be obvious that the same may be varied in many ways. Such variations are not to be regarded as a departure from the spirit and scope of the invention, and all such modifications as would be obvious to one of ordinary skill in the art are intended to be included within the scope of the following claims.

What is claimed is:

1. A method for tracking an individual having a schedule within a location comprising the steps:
storing unique identification data for a mobile device associated with the individual into a database;
storing a schedule for the individual into a server;
tracking, via at least one signal selected from the group consisting of Wi-Fi, GPS, Near Field Communication, and Bluetooth, the individual's location in at least one location, wherein the location is determined by a central access hub emanating a signal having a signal strength wherein the signal strength determines a location range for the signal emanating from the central access hub and wherein the central access hub is configured to search for the unique identification data within the location range;
matching unique identification data with the mobile device thereby connecting the mobile device to the central access hub;
tracking and logging the mobile device identification data once the individual's mobile device is within a pre-defined signal area as determined by the location range of the signal and, once the mobile device is connected to the central access hub;
retrieving the schedule of the individual;
in response to logging the mobile device identification, clocking in the individual if the employee is currently scheduled to be in the location according to the schedule and the individual has a corresponding application running on the mobile device;
indicating to the individual to run the corresponding application if the corresponding application is not running at the time the mobile device connects to the central access hub;
controlling the individual's use of certain websites and mobile applications as determined by an administrator;
periodically polling the mobile device using the server to collect mobile device information;
recording mobile device information in a log stored on the server;
automatically clocking out the individual from the at least one location if the individual disables the connection to the signal but preventing a clock out if the mobile device information indicates a mobile device battery level of less than at least 10% before any disabling of the connection to the signal;
allowing use of a secondary device for clocking out if the individual had a mobile device battery level of less than at least 10% before losing connection to the signal; and
reporting the recorded time spent at the location to the server to store in a central profile.

2. A method for tracking an individual having a pre-defined schedule within a location comprising the steps:
storing unique identification data for a mobile device associated with the individual into a database connected to a server;
tracking, via at least one signal, the individual's location in at least one location, wherein the location is determined by a central access hub emanating a signal, wherein the central access hub is configured to search for the unique identification data;
connecting the mobile device to the central access hub;
tracking and logging the mobile device once the individual's mobile device is within a pre-defined signal area as determined by the range of the signal and once the mobile device is connected to the central access hub;
in response to logging the mobile device, automatically clocking in the individual if the individual is currently scheduled to work according to the schedule and a corresponding application is running where the individual is prompted to launch the corresponding application if the corresponding application is not running when the mobile device connects to the central access hub; and
recording the time spent within the one location in real time; and
reporting the time spent at the location to the server to store in a central profile.

3. The method of tracking of claim 2 wherein the signal is a Wi-Fi signal.

4. The method of tracking of claim 2 wherein the signal is a Bluetooth signal.

5. The method of tracking of claim 2 wherein the signal is a GPS signal.

6. The method of tracking of claim 2 wherein the signal is a combination of Wi-Fi, Bluetooth, and GPS.

7. The method of tracking of claim 2 wherein the individual is an employee and the location is a work location.

8. The method of tracking of claim 2 wherein the individual is a student and the location is an academic setting.

9. The method of tracking of claim 2 wherein the server periodically polls the mobile device for mobile device information which determines whether to automatically clock the individual out of the location.

10. A system for tracking an individual having a pre-defined schedule within a location comprising:
a user;
a user's schedule;
a user's mobile device and corresponding user mobile device identification data;
a server designed to store user profiles;
a central access hub emanating a signal in a signal area connected to the server wherein the central access hub is configured to recognize a signal, to recognize when the user's mobile device is in the signal area through identification of the user mobile device identification data, to receive instructions from the server regarding appropriate Internet use by the user, to prompt the individual to launch appropriate applications, and to automatically record the active time of the user when the mobile device is connected to the central access hub.

11. The system of claim 10 wherein the signal is Wi-Fi.

12. The system of claim 10 wherein the signal is Bluetooth.

13. The system of claim 10 wherein the signal is GPS.

14. The system of claim 10 wherein the signal is a combination of Wi-Fi, Bluetooth, and GPS.

15. The method of claim 10 wherein the individual is an employee and the signal area is a work location.

16. The method of claim 10 wherein the individual is a student and the signal area is an academic setting.

17. The method of claim 10 wherein the server periodically polls the mobile device for mobile device information which determines whether to automatically clock the individual out of the location based on whether the mobile device communicates to the server but allowing for use of a secondary device for clocking out if the mobile device had a battery level of less than at least 10% based on previous polling performed by the server.
